(19) United States
(12) Patent Application Publication
(10) Pub. No.: US 2026/0181532 A1
(43) Pub. Date: Jun. 25, 2026

(54) METHOD OF RE-ACCESS AND RETRANSMISSION OPERATION

(71) Applicant: INTERDIGITAL PATENT HOLDINGS, INC., Wilmington, DE (US)

(72) Inventors: Jongwoo Hong, New York, NY (US); Martino Freda, Laval (CA); Paul Marinier, Brossard (CA); Erdem Bala, East Meadow, NY (US); Remun Koirala, London (GB); Patrick Tooher, Montreal (CA)

(73) Assignee: INTERDIGITAL PATENT HOLDINGS, INC., Wilmington, DE (US)

(21) Appl. No.: 18/988,542

(22) Filed: Dec. 19, 2024

(51) Int. Cl. H04W 48/16; H04W 74/0833

(52) U.S. Cl. CPC H04W 48/16; H04W 74/0833

(57) ABSTRACT

A method performed by a WTRU may comprise: receiving, from a network, configuration information, wherein the configuration information is associated with re-access operations; and performing a re-access operation based on at least one of: (1) a lack of D2R A-IoT resources for a D2R retransmission; (2) a lack of R2D A-IoT resources for a R2D retransmission; (3) an energy status of an A-IoT device; (4) an expiration of a D2R message running timer; (5) a measured A-IoT link quality; and (6) a priority of an UL transmission via Uu link.

### BACKGROUND

The Internet-of-Things (IoT) has garnered significant attention within the wireless communication industry. The increasing interconnection of devices promises to enhance productivity, improve efficiency, and elevate living standards. By further minimizing the size, complexity, and power consumption of IoT devices, it will become feasible to deploy tens or even hundreds of billions of devices across various applications, delivering substantial value throughout the entire value chain. However, relying on batteries to power such a vast number of devices poses several challenges, including high maintenance costs, environmental concerns, and potential safety risks (e.g., wireless sensor in electric power and petroleum industry).

Most wireless communication devices are powered by batteries that need to be manually replaced or recharged. The automation and digitalization of various industries opens new markets that require IoT technologies that support batteryless devices with no energy storage capability or devices with energy storage that do not need to be replaced or recharged manually. The form factor of such devices must be reasonably small to convey the validity of target use cases.

One example industry example is asset identification, which presently has to resort mainly to barcode and RFID in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

### SUMMARY

A method performed by a wireless transmit/receive unit (WTRU) may comprise: receiving, from a network, configuration information, wherein the configuration information is associated with re-access operations; and performing a re-access operation based on at least one of: (1) a lack of D2R A-IoT resources for a D2R retransmission; (2) a lack of R2D A-IoT resources for a R2D retransmission; (3) an energy status of an A-IoT device; (4) an expiration of a D2R message running timer; (5) a measured A-IoT link quality; and (6) a priority of an UL transmission via Uu link. The method may further comprise: transmitting, to a device, a first R2D message; receiving, from the device, a D2R message; and transmitting, to the device, a second R2D message. The WTRU may be a reader WTRU.

The first R2D message may trigger a random access channel (RACH) procedure. The received D2R message may be a MSG1 with a random number ID and the second R2D message may be a MSG2 with the random number ID. The second R2D message may be a command message. The second R2D message may indicate the D2R A-IoT resource. The WTRU may start the timer after transmitting the second R2D message. The priority of the UL transmission may indicate that the UL transmission overlaps with a R2D transmission.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an exemplary inventor procedure performed by a interrogator;

FIG. 3 illustrates an exemplary ambient IoT (A-IoT) topology;

FIG. 4 illustrates an exemplary A-IoT topology;

FIG. 5 illustrates an exemplary A-IoT topology;

FIG. 6 illustrates an exemplary A-IoT topology;

FIG. 7 illustrates an exemplary A-IoT topology;

FIG. 8 illustrates an exemplary re-access operation procedure;

FIG. 9 illustrates an exemplary retransmission procedure;

FIG. 10 illustrates an exemplary unsuccessful retransmission procedure;

FIG. 11 illustrates an exemplary procedure performed by a WTRU; and

FIG. 12 illustrates an exemplary procedure performed by a WTRU.

### DETAILED DESCRIPTION

The following acronyms and abbreviations may be referred to:
ACK Acknowledgement
A-IoT Ambient Internet-of-Thing
DL Downlink
D2R Device to Reader
HARQ Hybrid Automatic Repeat Request
IoT Internet-of-Things
LTE Long Term Evolution e.g. from 3GPP LTE R8 and up
NACK Negative ACK
MAC Media Access Control
MAC CE MAC Control Element
NR New Radio
OFDM Orthogonal Frequency-Division Multiplexing
PDU Packet Data Unit
PHY Physical Layer
PO Paging Occasion
PRACH Physical Random Access Channel
QoS Quality of Service
RA Random Access (or procedure)
RACH Random Access Channel
RAR Random Access Response
RFID Radio Frequency Identification
RN Random Number
RNTI Radio Network Identifier
RO RACH occasion
RRC Radio Resource Control
R2D Reader to Device
TID Tag-identification or Tag identifier
WTRU Wireless Transmit/Receive Unit
UL Uplink

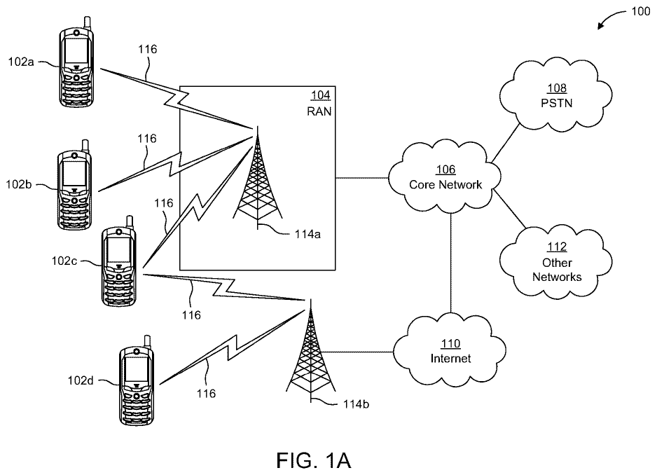

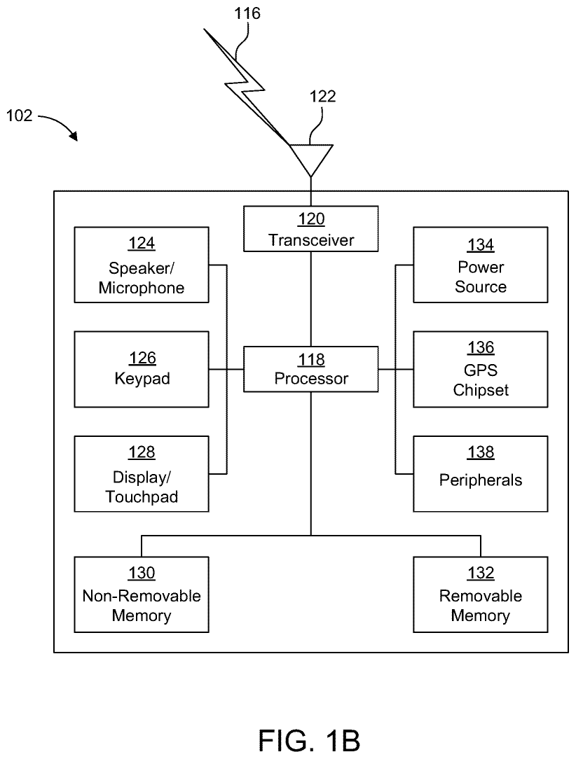

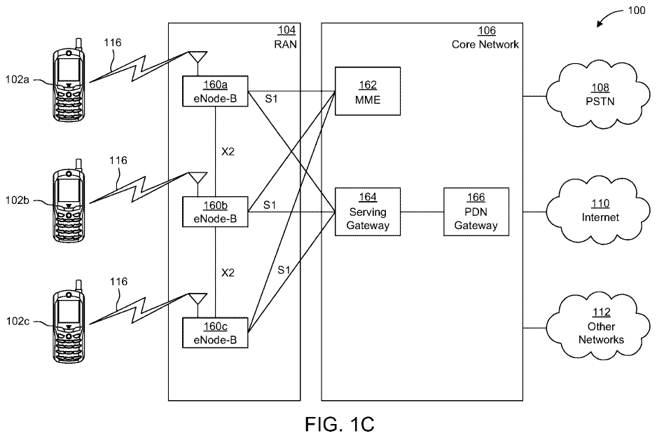

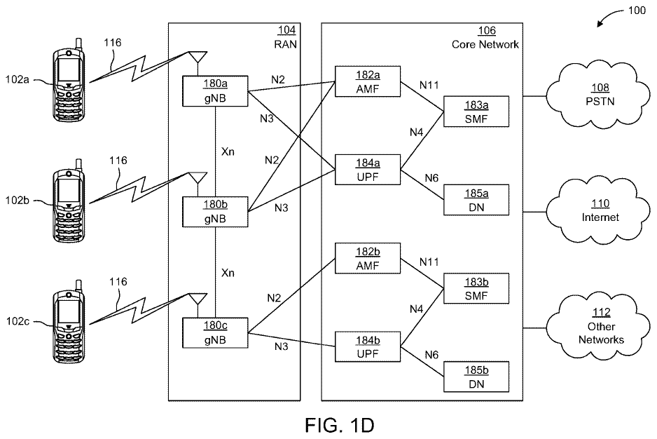

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95(IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

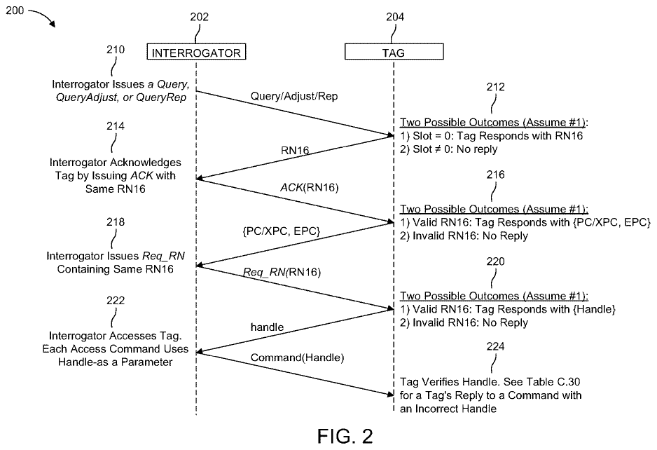

FIG. 2 illustrates an example procedure 200 in which an interrogator 202 inventories and accesses a single tag 204. Some implementations incorporate functions for an A-IoT compact protocol stack and lightweight signaling procedures to facilitate DO-DTT and DT data transmission. These implementations may support features such as paging, random access, data transmission (including essential radio resource control aspects), and interactions with upper communication layers.

At 210, the interrogatory 202 may issue a query message that initiates one round of the inventory procedure. The query message may include a parameter Q, which is used by the interrogator 202 to regulate the probability of a device/tag response. Upon receiving the query message (or queryadjust message), a tag 204 may select its slot counter to a value between 0 and 2^{Q-1} derived from the parameter Q. The tag 204 may then decrement its slot counter every time upon receiving a queryrep.

At 212, when the slot counter of the tag reaches zero, the device may transmit a 16-bit random number (RN16) message. If the slot counter equals 0, the tag 204 may send an RN16 message to the interrogator 202. If the slot counter does not equal 0, the tag 204 may not send the RN16 message (i.e., does not reply to the interrogator).

At 214, in response to the RN16 message (if received at 212), the interrogator 202 may acknowledge the reception of the R16 message by sending an acknowledgement (ACK), including the same R16 received from the tag 204.

At 216, on condition that the ACK at 214 includes a valid RN16 (e.g., the same RN16 generated/transmitted by the tag 204 at 212), the tag 204 may send a protocol control (PC)/extended protocol control (XPC), electronic product code (EPC) message to the interrogator 202. For example, upon receiving the valid RN16, the tag 204 may transmit the its unique identity information (e.g., PC/XPC, EPC). Otherwise, on condition that the ACK does not include a valid R16 (e.g., not the same RN16 generated/transmitted by tag at 212), the tag 204 may not send the PC/XPC, EPC message (i.e., does not reply to interrogator 202).

At 218, in response to receiving the PC/XPC, EPC message, the interrogator 202 may send a Req_RN message to the tag 204 (e.g., to check the successful reception of the PC/XPC EPC message from 216), including the same R16 as in the R16 message from 212 and ACK from 214.

At 220, on condition that the Req_RN message includes a valid R16, the tag sends a handle to interrogator. Otherwise, on condition that the Req_RN message does not include a valid R16, the tag 204 does not send a handle to the interrogator (i.e., does not reply to the interrogator).

At 222, after receiving the handle at 220, the interrogator 202 has access to the tag 204, and has the ability to issue commands using the handle as a parameter. The interrogator 202 may send a command message to the tag 204, which includes the handle as a parameter. At 224, the tag 204 may verify the handle before accepting the command.

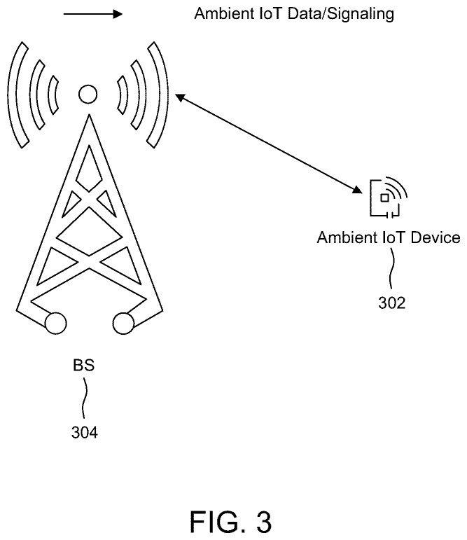

FIG. 3 illustrates an exemplary A-IoT topology where an A-IoT device communicates directionally and bidirectionally with a base station. As shown In FIG. 3, an A-IoT device 302 directly and bidirectionally communicates with a base station 304. The communication between the A-IoT device 302 and base station 304 may include A-IoT data and/or signaling. In the A-IoT topology shown in FIG. 3, the base station transmitting to the A-IoT device 302 may differ from the base station receiving data from it.

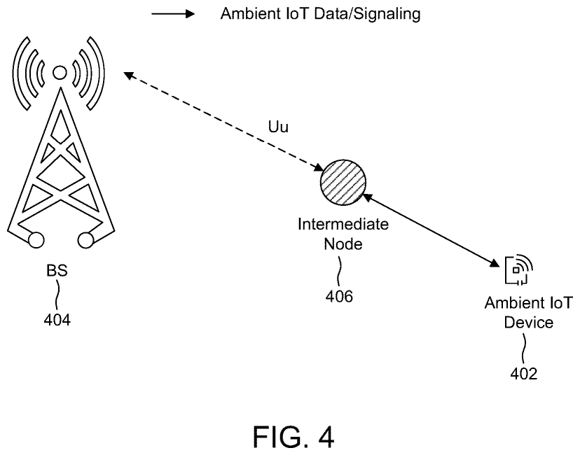

FIG. 4 illustrates an exemplary A-IoT topology where a A-IoT device communicates bidirectionally with an intermediate node. As shown in FIG. 4, an A-IoT device 404 communicates bidirectionally with an intermediate node 406 between the A-IoT device 402 and base station 404. In the topology illustrated in FIG. 4, the intermediate node 406 may be a relay, IAB node, WTRU, reader WTRU, and/or repeater, or any device that is capable of A-IoT. The intermediate node 406 may transfer the information between base station 404 and the A-IoT device 402.

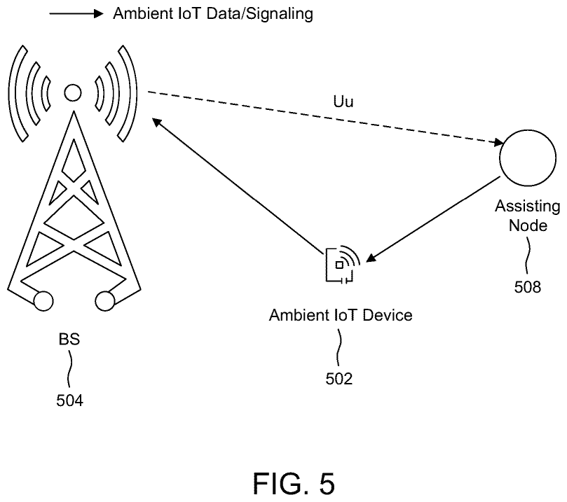

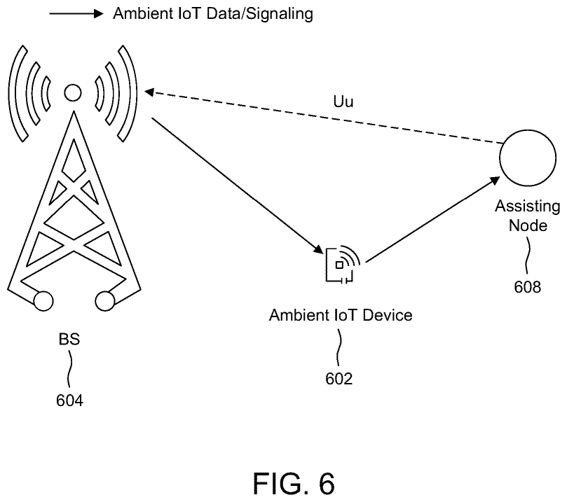

FIG. 5 illustrates an exemplary A-IoT topology with downlink assistance. As shown in FIG. 5, an A-IoT device 502 may transmit data/signaling to a base station 504, and may receive data/signaling from an assisting node 508. FIG. 6 illustrates an exemplary A-IoT topology with uplink assistance. As shown in FIG. 6, an A-IoT device 602 may receive data/signaling from a base station 604 and may transmit data/signaling to an assisting node 608. In the topologies illustrated in both FIG. 5 and FIG. 6, the assisting node (i.e., 508 and 608) may be a relay, IAB, WTRU, repeater, etc. which is capable of A-IoT).

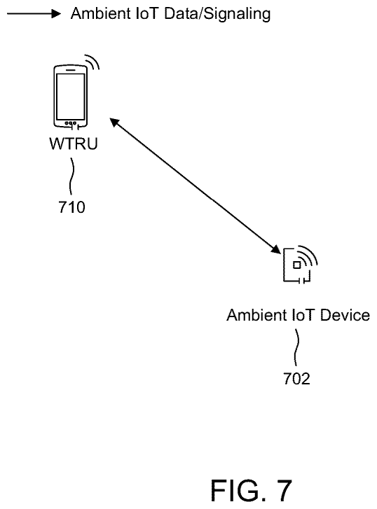

FIG. 7 illustrates an exemplary A-IoT topology where an A-IoT communicates bidirectionally with a WTRU. As shown in FIG. 7, an A-IoT device 702 may communicate bidirectionally with a WTRU 710. The communication between the A-IoT device 702 and the WTRU 710 may include A-IoT data and/or signaling.

The topology illustrated in FIG. 4 may include one or more reader WTRUs (e.g., intermediate nodes) performing A-IoT operations (inventory and/or command) with multiple A-IoT devices. As shown in FIG. 4, a reader WTRU may receive D2R message(s) from an A-IoT device and may determine how to handle re-access or retransmission for device(s) if the reader WTRU does not receive a D2R message (e.g., MSG3 and/or D2R data and/or D2R command response).

For example, if an reader WTRU does not receive the MSG3 (e.g., device ID and/or D2R data) from a device after transmitting the MSG2 (e.g., including the received random number ID), the reader WTRU may send an explicit feedback indication (e.g., 1-bit NACK or 1-bit for re-access) for performing re-access.

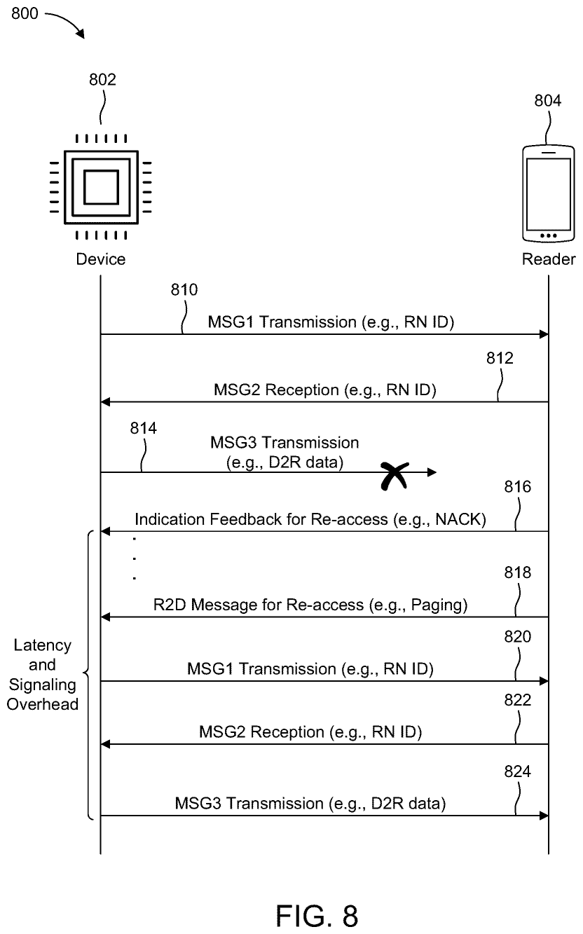

FIG. 8 illustrates an exemplary re-access operation 800 via an explicit feedback indication to a reader (e.g., reader WTRU). At 810, the reader 804 may receive a MSG1 transmission from a device 802. At 812, the reader 804 may transmit, to the device 802, a MSG2 transmission. At 814, the reader 804 may not receive the MSG3 transmission and at 816, the WTRU 804 may send, to the device 802, an explicit indication that it did not receive the MSG3 transmission. For example, the indication may be a NACK. Upon receiving the explicit indication, a device may perform re-access operation (e.g., triggering new RACH procedure).

At 818, the reader 804 may send a R2D message (e.g., paging) for re-access to the device 802. At 820, the reader 804 may receive a MSG1 transmission from the device 802. At 822, the reader 804 may transmit, to the device 802, a MSG2 transmission. At 824, the reader 804 may receive a MSG3 transmission from the device 802. For re-access operation, obviously there may be signaling overhead due to retransmission MSG1 and/or MSG2 and latency for this.

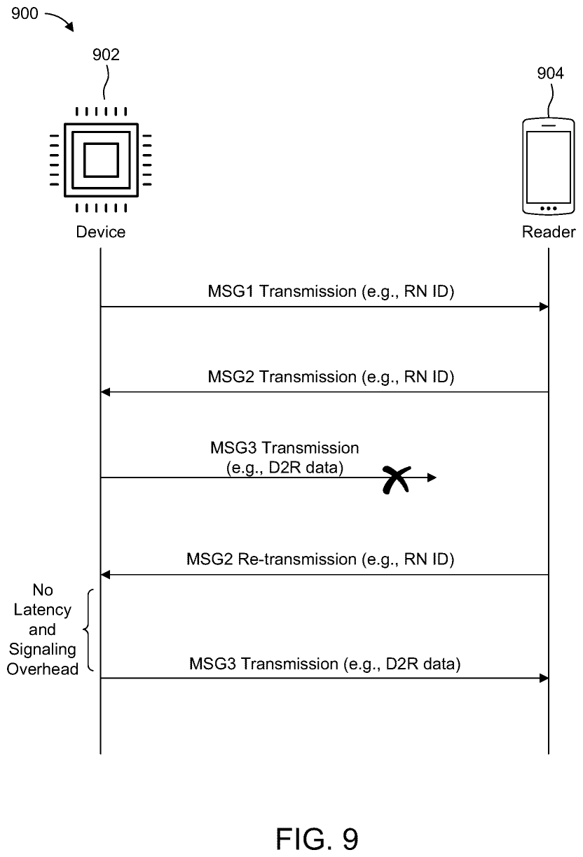

FIG. 9, illustrates an exemplary D2R retransmission procedure 900, via R2D retransmission with MSG2. As shown in FIG. 9, if a WTRU 904 does not receive a MSG3 from a device 902, the WTRU 904 may resend MSG2 as a request of MSG3 retransmission. The device 902 may perform retransmission of the MSG3 upon receiving MSG2.

As explained above, one or more readers may perform A-IoT operations (i.e., inventory and/or command procedure) with A-IoT devices. The readers and devices may communicate on resources which are managed by a base station (e.g., gNB). There are at least two potential actions that a reader may take when it does not receive a MSG3 from a device: (1) the reader may resend MSG2 (retransmission option) or (2) the reader may send an explicit feedback indication (optional) for performing re-access (re-access option).

Retransmission provides lower latency and reduced overhead compared to the re-access operation because it eliminates the need for additional signaling, such as sending a new D2R message (e.g., MSG1). As a result, prioritizing retransmission may appear more advantageous. Retransmission involves resending the R2D message (e.g., MSG2 or R2D command) when the D2R message (e.g., MSG3 or command response) from a device is not received.

However, the reader cannot always resend the R2D message (e.g., MSG2 or command) to request a retransmission of the D2R message because the device may sometimes lack sufficient resources to perform the retransmission. As a result, the device fails to complete the retransmission process.

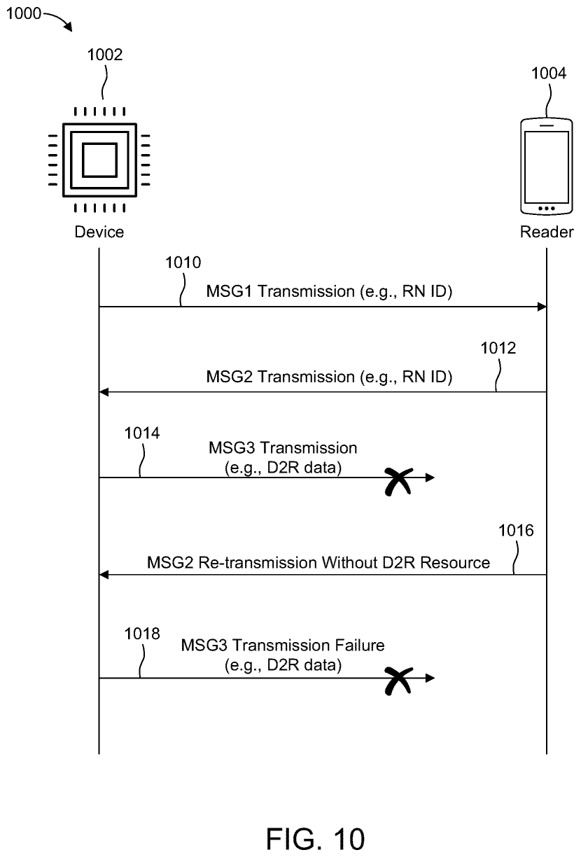

FIG. 10 illustrates an example of a D2R retransmission failure caused by insufficient D2R resources. Similar to FIG. 8, at 1010, the reader 1004 may receive a MSG1 transmission from a device 1002. At 1012, the reader 1004 may transmit, to the device 1002, a MSG2 transmission. At 1014, the reader 1004 may not receive the MSG3 transmission. At 1016, the reader 1004 may re-transmit the MSG2 to the device 1002 without D2R resource. At 1018, the device 1002 may determine a failure of the MSG3 retransmission.

Herein, the term of “WTRU” or “intermediate node” and “I-node” in may refer to the reader which, may be the entity that queries an A-IoT device. The term “reader” may refer to a network node or a WTRU, which may depend on the context and/or the topology of the system. The term “reader” in FIG. 3 may also refer to a network. In FIG. 3, the A-IoT device 302 may directly communicate with the network.

In this disclosure, the terms “device”, “ambient IoT (A-IoT) device”, and “tag” are used interchangeably to indicate the A-IoT device that is being inventoried/queried by the WTRU or network. Herein, the term “WTRU” may refer to the entity which queries the A-IoT device, either directly, or via an intermediate node (as shown in FIG. 4).

In FIG. 4, the A-IoT device 402 may communicate bidirectionally with the intermediate node 406 between the device and base station. In this topology, the intermediate node can be a relay (e.g., layer-2/layer-3), IAB node, WTRU, repeater, etc. which is capable of A-IoT. The intermediate node 406 may transfer A-IoT data and/or signaling between base station 404 and the A-IoT device 402.

Herein, the term “RACH,” “RACH procedure,” and “RA” may be used interchangeably to indicate an initial access procedure, random access, or RACH procedure in an inventory procedure. Herein, the term “core network,” or “CN” may be used interchangeably to indicate a core network entity (e.g., A-IoT function server, AMF and/or NR core network).

Herein, a query round may refer to the overall inventory procedure of a WTRU triggering access by multiple devices using a sequence of messages. The inventory procedure may refer to a single round of attempts to have each device respond or attempt to respond with its device ID or access ID. The inventory procedure may refer to a set of access occasions which may have 0 or at least 1 device respond within the access occasion. The inventory procedure may occur similar to legacy RFID procedure. Although referred to herein as inventory procedure, it may be termed differently in device requirements or specifications (e.g., query procedure, paging procedure, RACH procedure etc.).

Herein, an initial access (e.g., RACH) procedure may be initiated with a device's first transmission during an access occasion (e.g., slot counter in random access RFID). Such transmission may be similar to the transmission by the device in RFID inventory procedure to indicate the device ID. Such transmission may be followed by a confirmation of the device ID by the reader. Such transmission may be initiated by the device upon reception of an indication that an access occasion has been started. As with RFID, the indication of a start of an access occasion may be signaled in a message from the reader (e.g., in the query or queryadjust or queryrep message).

A device may initiate a RACH procedure only in a specific access occasion. The access occasions may be delimited by certain transmissions by the reader (e.g., similar to RFID where each query rep denotes the start of an occasion). Alternatively, a device may initiate RACH procedure in multiple occasions. Alternatively, a device may initiate RACH in an occasion indicated by the reader in the query message.

A device can perform either a contention-based or contention-free RACH procedure. In a contention-based RACH procedure, the device includes its device ID in a transmission based on its access occasion. For example, the device ID may be a 16-bit random or 16-bit pseudo-random number.

In a contention free RACH procedure, the device may transmit a different set of information compared to contention-based RACH procedure. In a contention-free RACH procedure, the device may omit including a device ID. In a contention-free RACH procedure, the device transmits a different set of information compared to the contention-based procedure. Here, the device may omit including a device ID if the initial message that initiates the access occasion (e.g., a query response or similar message) already contains the device ID. Instead, the device transmits configuration-related information or buffer status without including the device ID.

A command procedure may be initiated by a WTRU (e.g., reader) for one or more devices after completing an inventory procedure (e.g., RACH procedure, paging, and/or query process). For instance, a WTRU may trigger a command procedure for one or more devices once they have successfully completed the inventory procedure.

For example, during a command procedure, the WTRU may perform data communication with one or more devices via an A-IoT interface. The WTRU can send commands with operation requests such as read and/or write. For example, a read command may allow the WTRU to access all or part of the device's information (e.g., memory, EPC memory, TID memory). Similarly, a write command may enable the WTRU to write data or information into the device's memory (e.g., memory, EPC memory, TID memory).

In one example, a WTRU may receive, from a base station, a configuration of dedicated Uu resource or a certain time duration/period in the UL resource/UL link for A-IoT device(s) using an A-IoT interface. The configured Uu resource for A-IoT device(s) may include at least a resource set(s), a resource block(s), a time slot(s), a period time, a subframe(s), a group of UL resource grant(s), a time duration, a time window in the UL resource, and/or an UL link. For example, the one or more resources may be dedicated to A-IoT device, shared A-IoT devices and/or WTRUs (e.g., readers). For example, the one or more DL/UL resource may be a part of (or a portion of) resource and/or time duration/time window for a WTRU using Uu interface. For example, the one or more DL/UL resource of the frequency may be the same (and different) frequencies configured with Uu interface.

In one example, a configured resource for an A-IoT interface/A-IoT link may be associated with an inventory procedure and/or a command procedure. For example, the configured resource may be associated with a D2R transmission and/or a R2D transmission. The configured resource may be shared/used/selected by one or more A-IoT devices, a group of A-IoT devices, and/or all devices. For example, one dedicated Uu resource may be configured with one or more (dedicated) groups of A-IoT devices. For example, one dedicated Uu resource may be configured with all A-IoT devices. For example, one dedicated Uu resource may be associated at least one reception of D2R message and/or transmission of R2D message. For example, one Uu dedicated resource may be configured with specified A-IoT device types and/or device capabilities.

In one example, one Uu dedicated resource associated with an inventory procedure may include one or more parameters including one or more access occasions/slots/time and/or frequency resources (e.g., Q value) for initial transmission in one or more rounds.

In one example, a WTRU may receive conditions related to initiating a re-access procedure for a device. Each condition may correspond to a specific trigger for sending an explicit feedback indication for the re-access operation. For instance, the WTRU may send an explicit feedback indication if at least one of the conditions is met. The condition for re-access associated configuration and/or thresholds and/or measurement results. For example, available UL resource for A-IoT interface (e.g., D2R/R2D transmission) and/or receiving energy indication from a device and/or an expiry of timer and/or prioritization of UL transmission and/or a threshold of measurement results with Uu interface (e.g., measured RSRP/RSRQ/RSSI value) and/or a threshold of measurement results with A-IoT interface.

In one example, a WTRU may receive a configuration of one or more Uu resource for A-IoT interface via a broadcast and/or via a unicast message from a base station. The WTRU may receive the configuration via a broadcast message and/or dedicated message. For example, round initiated message, query message, queryadjust message, qureyrep message, an RRC message, SIB message. The WTRU may receive the configuration via a unicast message (e.g., SIB and/or RRC reconfiguration message).

A device may decide whether to perform a re-access operation or a retransmission operation after detecting a failure in D2R reception, failure in R2D transmission, or a collision in D2R message reception (e.g., receiving two random number IDs from different devices).

A WTRU may determine whether to perform a re-access operation based on configured conditions, such as when at least one condition for re-access is satisfied. The WTRU may transmit an explicit feedback indication to a device as either a response to or feedback on a D2R transmission. This explicit feedback indication may take the form of a 1-bit signal, where “1” indicates a re-access request and “0” represents an ACK. Alternatively, the feedback may indicate a NACK or a D2R message reception failure. For instance, an explicit feedback indication with an ACK may signal a request for consecutive D2R transmissions. Additionally, the explicit indication may be implicitly associated with at least one consecutive D2R message or be pre-configured with uplink resources for at least one R2D transmission.

A WTRU may perform a retransmission operation if at least one condition for re-access is not satisfied. For instance, the WTRU may retransmit a D2R message (e.g., MSG2, D2R data, or command) based on the last transmitted D2R message when the initial transmission fails, and no response is received from the device. Additionally, the WTRU may include scheduling information for specific or consecutive D2R messages in the retransmission.

A WTRU may determine to perform re-access for a device when at least one of the following conditions is satisfied:

A WTRU may determine to perform a re-access operation if there are no A-IoT resources available or no sufficient A-IoT resources available. In one example, a WTRU may not configure/schedule D2R resource for the D2R retransmission and/or initial and/or segmented transmission (e.g., MSG3 and/or D2R data and/or command response) due to no available D2R resource with the WTRU. For example, the WTRU may not be configured with D2R resource for a transmission of D2R message (e.g., (re-)configuration failure). For example, the WTRU may be configured with D2R resource with invalid and/or no available with valid D2R resource according to the validity criteria.

In one example, the configured available or remaining D2R resources may be insufficient to meet the payload requirements for the initial or retransmission of a D2R message (e.g., fixed or variable-length D2R messages). For example, the resources allocated for dynamic or semi-persistent transmissions may lack the necessary size or capacity (e.g., bits or bytes) to accommodate the corresponding D2R message. In some cases, no available or remaining D2R resources are left for the transmission of a D2R message.

In one example, a WTRU may be unable to (re)transmit an R2D message (e.g., MSG2, D2R data, or a command) to a device if the available or remaining R2D resources are insufficient to meet the payload requirements for the (re)transmission. For example, the remaining R2D resources may only be adequate for transmitting an explicit feedback indication, such as a re-access request or NACK, but not for the full R2D message.

A WTRU may determine to perform a re-access operation upon receiving the energy status of the device.

In one example, a device may transmit an indication of its energy status (e.g., low, medium, high, or a request for charging) to a WTRU. This indication may be sent via a D2R message, such as MSG1, MSG3, or a command response.

In one example, upon receiving an energy status indication from a device, the WTRU may decide to transmit an explicit feedback indication instructing the device to perform a re-access operation based solely on the energy status indication, without requiring D2R data or additional D2R messages. The feedback indication may include a specified time window or duration before the device re-initiates the re-access procedure. The indication may specify one or more paging rounds that may occur before re-access is performed.

A WTRU may determine to perform a re-access operation upon expiration of a timer. In one example, a WTRU may determine to transmit an explicit feedback indication when a timer (e.g., for D2R retransmission) expires. The WTRU may start this timer after sending an R2D message or retransmitting an R2D message (e.g., MSG2, R2D data, or command). The timer may be considered expired if the WTRU does not receive a D2R message (e.g., MSG1, MSG3, D2R data, or a command response) while the timer is running. The timer value may be determined based on the configuration of repetitions for the D2R transmission. For example, a longer timer value may correspond to a larger number of D2R message repetitions or a higher maximum transmission power, while a shorter timer value may correspond to fewer repetitions or a lower transmission power.

In another example, a WTRU may determine to transmit an explicit feedback indication when a service request timer expires. The WTRU may receive a latency requirement, along with the associated timer value, from the core network as part of the service request. This latency requirement may correspond to at least one QoS level (e.g., milliseconds, seconds, or minutes). The WTRU may also receive assistance information from the core network regarding the QoS level and latency requirement for inventory or command procedures. Upon receiving the service request, the WTRU starts the timer. If the WTRU does not receive the first D2R message (e.g., MSG1) from the device while the timer is active, it determines that the timer has expired. In one example, a WTRU may determine to transmit an explicit feedback indication with a timer value for a D2R transmission.

A WTRU may determine to perform a re-access operation upon based on prioritization. In one example, a WTRU may decide to transmit an explicit feedback indication when an UL transmission is prioritized over an A-IoT transmission. For example, this prioritization may occur when the WTRU is configured with dedicated UL resources (e.g., an UL grant) or a time window/duration that overlaps with both UL transmission and A-IoT transmission or reception.

In one example, a network may configure a prioritization rule or level for overlapping UL resources within a specified time window or duration. For example, a UL transmission may be prioritized if the buffer size exceeds a defined threshold (e.g., in bits or bytes) or if the latency of the UL transmission is below a specified threshold (e.g., in slots or milliseconds).

In one example, a network may configure prioritization levels for UL transmission and/or A-IoT R2D transmission/D2R reception through signaling mechanisms such as DCI, MAC CE, SIB, or an RRC message (e.g., a dedicated message). Upon receiving the prioritization level configuration, the WTRU may determine whether to prioritize UL transmission or A-IoT transmission/reception when UL resources overlap with both UL and A-IoT activities. For example, the WTRU may apply the configured prioritization level to decide the appropriate action during the overlapping resource allocation.

A WTRU may determine to perform a re-access operation upon based on an A-IoT measurement. In one example, a WTRU may decide to transmit an explicit feedback indication when the measurement results of the A-IoT link fall below the configured threshold (e.g., for the A-IoT interface) and/or when the measurement results of the Uu link exceed the configured threshold (e.g., for the Uu interface). For instance, the WTRU may measure the quality of the A-IoT link upon receiving a D2R message from a device. The quality of the A-IoT interface can be assessed based on measurement results such as RSSP, RSRQ, or RSSI values derived from the received D2R message. Similarly, the quality of the Uu interface can be evaluated using measurement results (e.g., RSSP, RSRQ, or RSSI) obtained from a downlink reference signal, such as an SSB index, DL-RS, or CSI-RS.

Combinations of the above factors are also possible for determining whether to perform a re-access operation.

In one example, a WTRU may transmit an explicit feedback indication with additional timing information. For example, an explicit feedback indication may include a time offset/back-off time that may indicate when a device initiates performing re-access. For example, the time offset may comprise a certain time value/time window/time gap/time duration/back-off timer value/a number of paging round/a number of access occasions, etc. For example, a WTRU may determine the offset value based on conditions (e.g., interference level and/or congestion level and/or number of attempt failures of D2R transmission). For example, a WTRU may be configured the time offset value from network. The (pre-)configured time offset value is associated with interference/congestion level in the Uu link. For example, the device may initiate performing re-access after the configured timing offset/back-off time is applied. For example, the UL message may comprise an explicit feedback indication and specific time offset value.

In one example, upon transmitting an explicit feedback indication for re-access with a specific time offset value, then a WTRU may request additional D2R and/or R2D resource for A-IoT link to a network before device initiates re-access operation. For example, upon transmitting an explicit feedback indication to the device, a WTRU may request additional D2R resource and/or R2D resource and/or request to perform reconfiguration for D2R/R2D resource of A-IoT interface. For example, an UL message for resource request and/or resource reconfiguration may comprise and delivered/transmitted via one of these, e.g., User Control Information (UCI) and/or Scheduling Request (SR) and/or Buffer Status Report (BSR) and/or MAC Control Element (MAC CE) and/or RRC message. For example, the UL message may comprise an indication (e.g., 1 bit) that indicates resource allocation request and/or reconfiguration for A-IoT interface/devices.

In one example, a WTRU may receive a configuration including A-IoT resource for D2R reception/D2R transmission and associated conditions for re-access or retransmission from a network.

Upon transmitting an R2D message, a WTRU may determine whether to perform re-access or retransmission for the device. For example, the WTRU may determine to re-access when at least one of the configured conditions for configured re-access operation is satisfied. A WTRU may determine to re-access or retransmission operation based on conditions, for example, whether configured available D2R resource and/or upon detecting a collision and/or upon receiving an indication from a device and/or timer expiry of R2D reception and/or prioritization rule and/or measurement results. For example, if any condition for re-access operation is not satisfied, a WTRU may perform retransmission (e.g., MSG2 and/or D2R data and/or command) for the device.

In one embodiment, upon detecting a D2R message failure (e.g., MSG3, D2R data), a WTRU may determine whether to send an indication for re-access or resend a MSG2 for retransmission based on the configured conditions.

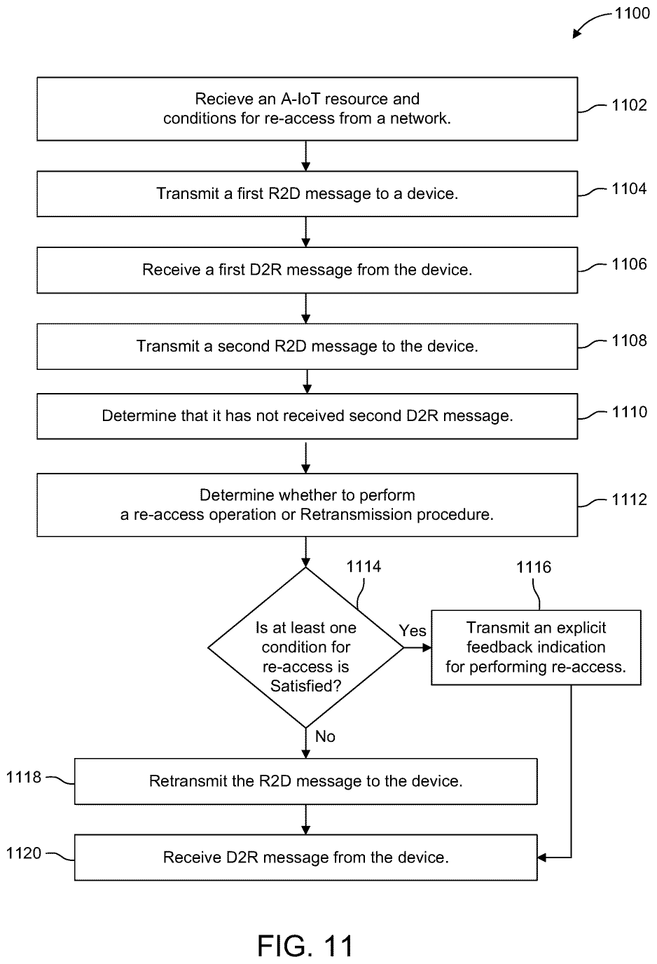

FIG. 11 illustrates an exemplary procedure 1000 performed by a WTRU for determining whether to perform a re-access operation or a retransmission procedure.

At 1102, a WTRU (e.g., reader WTRU) may receive, from a network, A-IoT configuration information for initial transmission and retransmissions. The A-IoT configuration information may include dedicated A-IoT resource and/or time duration in UL (e.g., D2R and/or R2D resource) and conditions to determine whether to use re-access or retransmission.

At 1104, the WTRU may, upon receiving a service request message from the network (e.g., core network), transmit a first transmission (e.g., a R2D transmission for RACH procedure triggering message (e.g., paging message)) to one or more devices

At 1106 the WTRU may then receive a second transmission (e.g., a D2R message (e.g., MSG1 with random number ID)) from the device and transmits a third transmission (e.g., a R2D message (e.g., MSG2 with the received random number ID)) to the device.

At 1108, the WTRU may transmit a third transmission (e.g., a R2D message (e.g., MSG2 with the received random number ID)) to the device.

At 1110, the WTRU may then determines that it has not received a fourth transmission (e.g., a D2R message (e.g., MSG3 or response to a command)) in the resources indicated in the third transmission.

At 1112, the WTRU may then determine whether to perform a re-access operation or a retransmission operation based on at least one of the following:

The WTRU may then determine whether to perform a re-access operation or a retransmission operation based on a configured condition.

The WTRU may then determine whether to perform a re-access operation or a retransmission operation based on the configured D2R A-IoT resource (e.g., a resource indicated in the third transmission) is not available (or does not satisfy the payload requirements) for the D2R retransmission.

The WTRU may then determine whether to perform a re-access operation or a retransmission operation based on receiving an indication of energy status (e.g., low energy) from the device.

The WTRU may then determine whether to perform a re-access operation or a retransmission operation based on whether the timer for waiting on the D2R message has expired.

The WTRU may then determine whether to perform a re-access operation or a retransmission operation based on whether the measured A-IoT link quality with the device is below a configured threshold.

The WTRU may then determine whether to perform a re-access operation or a retransmission operation based on the prioritization of an UL transmission via the Uu link (e.g., when UL transmission overlaps with R2D transmission on the Uu link).

The WTRU may then determine whether to perform a re-access operation or a retransmission operation based on an expiration of a service request that triggered the first transmission.

At 1116, If at least one of the above conditions is satisfied, the WTRU may determine to perform a re-access operation. If the WTRU determines to perform a re-access operation, the WTRU may transmit an explicit failure indication to the device and transmit a fifth transmission (e.g. a R2D transmission for RACH procedure triggering message (e.g., a paging message)).

At 1118, if none of the above conditions is satisfied, the WTRU may determine to perform a retransmission. If the WTRU determines to perform a retransmission, the WTRU may transmit an explicit failure indication to the device and transmits a fifth transmission (e.g. a R2D transmission for RACH procedure triggering message (e.g., a paging message)).

At 1120, the WTRU may receive a D2R message from the device.

The described embodiment enables the WTRU to decide whether to perform a re-access operation or a retransmission when a D2R message reception fails. The WTRU may successfully receive the required D2R message immediately or later, depending on various conditions.

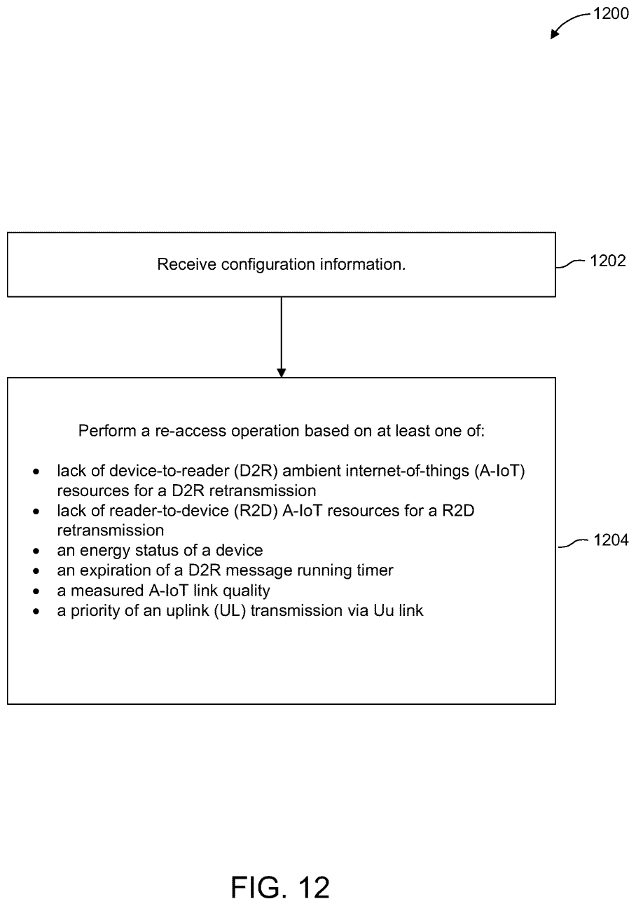

FIG. 12 shows an exemplary procedure in which a WTRU determines whether to perform a re-access operation. At 1202, the WTRU may receive, from a network, configuration information, wherein the configuration information is associated with re-access operations. At 1204, the WTRU performs a re-access operation based on at least one of: (1) a lack of D2R A-IoT resources for a D2R retransmission; (2) a lack of R2D A-IoT resources for a R2D retransmission; (3) an energy status of a device; (4) an expiration of a D2R message running timer; (5) a measured A-IoT link quality; and (6) a priority of an UL transmission via Uu link.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a wireless transmit/receive unit (WTRU), the method comprising:
receiving, from a network, configuration information, wherein the configuration information is associated with re-access operations;
performing a re-access operation based on at least one of:
lack of device-to-reader (D2R) ambient internet-of-things (A-IoT) resources for a D2R retransmission;
lack of reader-to-device (R2D) A-IoT resources for a R2D retransmission;
an energy status of an A-IoT device;
an expiration of a D2R message running timer;
a measured A-IoT link quality; and
a priority of an uplink (UL) transmission via Uu link.

2. The method of claim 1, further comprising:
transmitting, to a device, a first R2D message;
receiving, from the device, a D2R message; and
transmitting, to the device, a second R2D message.

3. The method of claim 2 wherein the first R2D message triggers a random access channel (RACH) procedure.

4. The method of claim 2 wherein the received D2R message is a MSG1 with a random number ID and the second R2D message is a MSG2 with the random number ID.

5. The method of claim 2, wherein the second R2D message is a command message.

6. The method of claim 2, wherein the second R2D message indicates a D2R A-IoT resource.

7. The method of claim 2, wherein the WTRU starts the timer after transmitting the second R2D message.

8. The method of claim 1, wherein the re-access operation includes:
transmitting, to the device, an indication that a D2R message was not received;
transmitting, to the device, a R2D message for re-access; and
receiving, from the device, a D2R message.

9. The method of claim 8, wherein the D2R message one of an MSG3 or a command response message.

10. The method of claim 1, wherein the priority of the UL transmission indicates that the UL transmission overlaps with a R2D transmission.

11. A wireless transmit/receive unit (WTRU), comprising:
a transceiver; and
a processor;
wherein the transceiver is configured to receive, from a network, configuration information, wherein the configuration information is associated with re-access operations;
wherein the transceiver and processor are configured to perform a re-access operation based on at least one of:
lack of device-to-reader (D2R) ambient internet-of-things (A-IoT) resources for a D2R retransmission;
lack of reader-to-device (R2D) A-IoT resources for a R2D retransmission;
an energy status of an A-IoT device;
an expiration of a D2R message running timer;
a measured A-IoT link quality; and
a priority of an uplink (UL) transmission via Uu link.

12. The WTRU of claim 11, wherein the transceiver and processor are further configured to:
transmit, to the device, a first R2D message
receive, from the device, a D2R message; and
transmit, to the device, a second R2D message.

13. The WTRU of claim 12 wherein the first R2D message triggers a random access channel (RACH) procedure.

14. The WTRU of claim 12 wherein the D2R message is a MSG1 with a random number ID and the second R2D message is a MSG2 with the random number ID.

15. The WTRU of claim 12, wherein the second R2D message is a command message.

16. The WTRU of claim 12, wherein the second R2D message indicates a D2R A-IoT resource.

17. The WTRU of claim 12, wherein the WTRU starts the timer after transmitting the second R2D message.

18. The WTRU of claim 11, wherein the re-access operation includes:
transmitting, to the device, an indication that a D2R message was not received;
transmitting, to the device, a R2D message for re-access; and
receiving, from the device, a D2R message, wherein the D2R message is a MSG3.

19. The WTRU of claim 18, wherein the D2R message is one of a MSG3 message or a command response message.

20. The WTRU of claim 11, wherein the priority of the UL transmission indicates that the UL transmission overlaps with a R2D transmission.
